(19) United States
(12) Patent Application Publication
(10) Pub. No.: US 2010/0081053 A1
(43) Pub. Date: Apr. 1, 2010

(54) Negative electrode for alkaline storage battery, alkaline storage battery, and method of manufacturing alkaline storage battery

(76) Inventor: Jun Ishida, Kobe-shi (JP)

Correspondence Address: KUBOVCIK & KUBOVCIK, SUITE 1105, 1215 SOUTH CLARK STREET, ARLINGTON, VA, 22202, US

(21) Appl. No.: 12/588,015

(22) Filed: Sep. 30, 2009

(30) Foreign Application Priority Data
Sep. 30, 2008 (JP) 2008-254917
Jul. 3, 2009 (JP) 2009-158418

(51) Int. Cl. H01M 4/58; H02J 7/00

(52) U.S. Cl. 429/218.2; 320/130

(57) ABSTRACT

A negative electrode for alkaline storage batteries uses a hydrogen-absorbing alloy represented by the general formula Ln₁₋ₓMgₓNi_{y-a-b}AlₐM_{b}, having a crystal structure other than CaCu₅ type. First to third layers S1 to S3 are formed on the surface of the bulk phase B of the hydrogen-absorbing alloy. The first layer closest to the bulk phase contains oxygen in a greater amount than the second layer located on the first layer, and contains at least one element soluble in an alkaline solution in an amount of 10 atom % or greater. The second layer located on the first layer has a Ni content higher than that of the bulk phase. The third layer located on the second layer has a NiO content higher than the NiO content in the second layer.

### BACKGROUND OF THE INVENTION

1. Field of the Invention

The present invention relates to a negative electrode for alkaline storage batteries that employs a hydrogen-absorbing alloy, an alkaline storage battery using the negative electrode, and a method of manufacturing the alkaline storage battery. More particularly, the invention relates to improvements in a hydrogen-absorbing alloy having a crystal structure other than CaCu₅ type when employing the hydrogen-absorbing alloy as the negative electrode for alkaline storage batteries so that power characteristics and charge-discharge cycle performance under a low temperature environment can be improved sufficiently.

2. Description of Related Art

Conventionally, nickel-cadmium storage batteries have been widely used as alkaline storage batteries. In recent years, nickel-metal hydride storage batteries using a hydrogen-absorbing alloy as a material for the negative electrode have drawn considerable attention, from the viewpoints that they achieve higher capacity than nickel-cadmium storage batteries, and that they are environmentally safer because they do not contain cadmium.

In recent years, alkaline storage batteries employing the nickel-metal hydride storage batteries have been used in various applications such as various portable devices and hybrid electric vehicles. As a result, it has been expected to further improve various characteristics of the alkaline storage batteries under a wide range of environmental conditions.

The alkaline storage batteries generally employ, as the negative electrode material, a hydrogen-absorbing alloy such as a rare earth-nickel hydrogen-absorbing alloy having a CaCu₅ crystal structure as its main phase and a AB₂ Laves phase hydrogen-absorbing alloy.

However, the hydrogen-absorbing alloys mentioned above do not have sufficient hydrogen-absorbing capability. Therefore, it has been difficult to achieve sufficient capacity in the alkaline storage batteries. In addition, it has been unable to obtain sufficient power characteristics and charge-discharge cycle performance under low temperature conditions.

As disclosed in Patent Documents 1 and 2, for example, it has been proposed to use a rare earth-Mg—Ni-based hydrogen absorbing alloy having a crystal structure other than CaCu₅ type, in which Mg or the like is contained in the rare earth-nickel hydrogen absorbing alloy, and also to control the amount of Ni in the vicinity of the surface of the hydrogen-absorbing alloy to be greater than the bulk phase inside the hydrogen-absorbing alloy.

The rare earth-Mg—Ni-based hydrogen-absorbing alloy as described above has higher hydrogen-absorbing capability than the rare earth-nickel hydrogen absorbing alloy having a CaCu₅ type crystal structure as its main phase. It also tends to cause cracks more easily, and the resulting newly formed surfaces, which show high reactivity, contribute to the discharge reaction, so it shows relatively good discharge characteristics at low temperatures and good discharge capacity during high rate discharge.

In addition, Patent Document 3 proposes a hydrogen-absorbing alloy electrode in which a surface layer containing a greater amount of Ni than the bulk phase inside the hydrogen-absorbing alloy is provided on the surface of the hydrogen-absorbing alloy, and the particle size of the Ni particles in the surface layer is set to be within the range of from 10 nm to 50 nm so that the low temperature discharge capability and the high-rate discharge capability in the alkaline storage battery can be improved.

However, even when the amount of Ni is increased in the alloy surface layer or even when the hydrogen-absorbing alloy is used in which the particle size of the Ni particles in the alloy surface layer is controlled, it has been unable to improve power characteristics and charge-discharge cycle performance under low temperature conditions sufficiently. Therefore, it has been difficult to suitably use the alkaline storage batteries employing the hydrogen-absorbing alloy as the power source for hybrid electric vehicles and power tools, which require use in very low temperature environmental conditions.

[Patent Document 1] Japanese Published Unexamined Patent Application No. 2000-80429

[Patent Reference 2] Japanese Published Unexamined Patent Application No. 2002-69554

[Patent Reference 3] Japanese Published Unexamined Patent Application No. 2007-87886

### BRIEF SUMMARY OF THE INVENTION

It is an object of the present invention to solve the foregoing and other problems in the alkaline storage battery. Specifically, it is an object of the present invention to improve a hydrogen-absorbing alloy having a crystal structure other than CaCu₅ type when employing the hydrogen-absorbing alloy for the negative electrode of an alkaline storage battery, so that power characteristics and charge-discharge cycle performance under a low temperature environment can be improved sufficiently, and to provide an alkaline storage battery that can be used suitably for a power source for hybrid electric vehicles and power tools.

In order to solve the foregoing and other problems, the present invention provides a negative electrode for alkaline storage batteries, comprising a hydrogen-absorbing alloy represented by the general formula Ln₁₋ₓMgₓNi_{y-a-b}AlₐM_{b}, where: Ln is at least one element selected from the group consisting of Zr, Ti, and rare-earth elements including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9, the hydrogen-absorbing alloy having three layers layered on a surface of a bulk phase of the hydrogen-absorbing alloy, the three layers being first to third layers, wherein: the first layer located on the bulk phase contains oxygen in a greater amount than the second layer located on the first layer and contains at least one element soluble in an, alkaline solution in an amount of 10 atom % or greater; the second layer located on the first layer has a higher Ni content than the bulk phase; and the third layer located on the second layer has a higher NiO content than that in the second layer.

In the above-described negative electrode for alkaline storage batteries, it is preferable that the third layer contain NiO and metallic Ni. When NiO exists in addition to metallic Ni, metallic Ni particles are inhibited from bonding with each other, so the reaction area of the metallic Ni that serves as the catalyst in the charge-discharge reaction is inhibited from decreasing.

When the amount of NiO is small in the third layer, it is impossible to prevent metallic Ni particles from bonding with each other sufficiently. Therefore, it is preferable that the percentage of the amount of Ni within the NiO be 20% or greater with respect to the total amount of Ni within the NiO and the metallic Ni, more preferably 40% or greater. On the other hand, when the amount of NiO is too large in the third layer, the amount of metallic Ni that serves as the catalyst in the charge-discharge reaction becomes small. Therefore, it is preferable that the percentage of the amount of Ni within the NiO be 99% or less with respect to the total amount of Ni within the NiO and the metallic Ni.

In addition, when the third layer contains large amounts of elements other than NiO and metallic Ni, the charge-discharge reaction may deteriorate. Therefore, it is preferable that the total amount of oxygen and Ni in the third layer be 90 atom % or greater.

Moreover, when the thickness of the third layer is thin, the bulk phase of the hydrogen-absorbing alloy cannot be inhibited sufficiently from being corroded by the alkaline electrolyte solution. On the other hand, when the thickness of the third layer is too thick, the discharge performance at around room temperature becomes poor. Therefore, it is preferable that the thickness of the third layer be from 10 nm to 100 nm, more preferably from 40 nm to 70 nm.

When the grain size of the crystal grains existing in the third layer is too large, the reaction area that serves as the catalyst in the charge-discharge reaction is small. For this reason, it is preferable that the grain size of the just-mentioned crystal grains be 7 nm or less, more preferably 5 nm or less. However, when the grain size of the crystal grains existing in the third layer is too small, the catalytic action to the charge-discharge reaction lowers. Therefore, it is preferable that the grain size of the crystal grains be 2 nm or greater.

On the other hand, when the grain size of the crystal grains existing in the second layer is small, charge transfer does not take place smoothly. Therefore, it is preferable that the grain size of the crystal grains existing in the second layer be greater than the grain size of the crystal grains existing in the third layer, and that the crystal grains in the second layer include those having a grain size of 10 nm or greater. However, when the grain size of the crystal grains existing in the second layer also is too large, the reaction area that serves as the catalyst in the charge-discharge reaction becomes small. In addition, too large a grain size restricts proton transfer, resulting in poor reactivity. Therefore, it is preferable that the grain size of the crystal grains in the second layer be 50 nm or less.

Examples of the element contained in the first layer that is soluble in an alkaline solution include Ln, Al, and Mg, shown in the foregoing general formula. When such an element that is soluble in an alkaline solution is contained in an amount of 10 atom % or greater as described above, the first layer is corroded by the alkaline electrolyte solution. However, because of this first layer, the bulk phase located underneath is inhibited from being corroded by the alkaline electrolyte solution. In particular, when the third layer as described above exists, the first layer is also inhibited from being corroded by the alkaline electrolyte solution, and the bulk phase is further inhibited from being corroded by the alkaline electrolyte solution. As a result, the durability of the bulk phase improves significantly.

When using the above-described hydrogen-absorbing alloy for the negative electrode, the surface area that shows high reactivity becomes small if the particle size of the hydrogen-absorbing alloy is large. Therefore, it is preferable that the hydrogen-absorbing alloy have a volume average particle size of 70 μm or less.

The alkaline storage battery of the present invention employs a negative electrode for alkaline storage batteries that uses the above-described hydrogen-absorbing alloy for its negative electrode.

Here, the negative electrode for alkaline storage batteries that employs the hydrogen-absorbing alloy as described above may be obtained in the following manner. A hydrogen-absorbing alloy represented by the general formula Ln₁₋ₓMgₓNi_{y-a-b}AlₐM_{b} is subjected to an oxidation treatment to form an oxide layer containing NiO on the surface of the hydrogen-absorbing alloy. Thereafter, the hydrogen-absorbing alloy is caused to undergo a charge-discharge reaction, to form the first to the third layers on the surface of the hydrogen-absorbing alloy.

In order to manufacture the alkaline storage battery as described above efficiently, it is preferable that the negative electrode using the hydrogen-absorbing alloy having an oxide layer containing NiO on the surface be charged and discharged in the alkaline storage battery to form the first to the third layers on the surface of the hydrogen-absorbing alloy.

To form an oxide layer containing NiO on the surface of the hydrogen-absorbing alloy by subjecting the hydrogen-absorbing alloy represented by the general formula Ln₁₋ₓMgₓNi_{y-a-b}AlₐM_{b} to an oxidation treatment, it is desirable that the hydrogen-absorbing alloy be oxidized by subjecting the hydrogen-absorbing alloy to a heat treatment in an atmosphere containing oxygen.

When subjecting the hydrogen-absorbing alloy to a heat treatment in an atmosphere in which oxygen exists to oxidize the hydrogen-absorbing alloy, it will become difficult to oxidize the hydrogen-absorbing alloy appropriately if the oxygen concentration in the atmosphere and the heat treatment temperature are low. For this reason, it is preferable that the heat treatment be carried out in an atmosphere having an oxygen concentration of 1% or higher at a temperature of 150° C. or higher. However, when the heat treatment temperature is too high, the surface of the hydrogen-absorbing alloy is oxidized excessively. Therefore, it is preferable that the heat treatment temperature be set at 300° C. or lower.

When using the hydrogen-absorbing alloy represented by the general formula Ln₁₋ₓMgₓNi_{y-a-b}AlₐM_{b} in which the first to the third layers are layered on the bulk phase surface of the hydrogen-absorbing alloy as the negative electrode in the alkaline storage battery of the present invention, the following advantageous effects are obtained. Since NiO is present in the third layer located as the outermost surface of the hydrogen-absorbing alloy, metallic Ni particles are inhibited from bonding to each other, and the reaction area of the metallic Ni that serves as the catalyst of the charge-discharge reaction increases. In addition, charge transfer takes place smoothly because of the second layer located under the third layer, so the charge-discharge reaction at low temperatures takes places smoothly.

Moreover, because of the third layer, which is located as the outermost surface of the hydrogen-absorbing alloy, and the first layer, which is located on the bulk phase and contains an element soluble in an alkaline solution in an amount of 10 atom % or greater, the bulk phase of the hydrogen-absorbing alloy is inhibited from being corroded by the alkaline electrolyte solution, and the hydrogen-absorbing alloy is prevented from deteriorating due to charge and discharge.

As a result, with the alkaline storage battery of the present invention, power characteristics under a low temperature environment and charge-discharge cycle performance are improved sufficiently. Thus, the alkaline storage battery can be used suitably as a power source for hybrid electric vehicles and power tools.

### BRIEF DESCRIPTION OF THE DRAWINGS

FIG. 1 is a schematic cross-sectional view illustrating an alkaline storage battery prepared for Example 1 of the present invention and Comparative Examples 1 and 2;

FIG. 2 is a micrograph showing a cross section of the hydrogen-absorbing alloy in an alkaline storage battery of Example 1;

FIG. 3 is a micrograph showing a cross section of the hydrogen-absorbing alloy in an alkaline storage battery of Comparative Example 1;

FIG. 4 is a micrograph showing a cross section of the hydrogen-absorbing alloy in an alkaline storage battery of Comparative Example 3; and

FIG. 5 is a schematic illustrative drawing of a test cell prepared for Examples 1a to 4a of the invention and Comparative Example 1a.

### DETAILED DESCRIPTION OF THE INVENTION

### Examples

Hereinbelow, examples of the negative electrode for alkaline storage batteries, the alkaline storage battery employing the negative electrode for alkaline storage batteries, and the method of manufacturing them according to the present invention will be described in detail. In addition, it will be demonstrated that the examples of the alkaline storage battery employing the negative electrode for alkaline storage batteries according to the invention achieves sufficient improvements in power characteristics under a low temperature environment and good charge-discharge cycle performance, in comparison with comparative examples. It should be noted that the negative electrode for alkaline storage batteries and the alkaline storage battery according to the invention are not limited to those illustrated in the following examples, and various changes and modifications are possible within the scope of the invention.

### Example 1

In preparing an alkaline storage battery, Example 1 used a negative electrode and a positive electrode that were prepared in the following manner.

### Preparation of Negative Electrode

The negative electrode was prepared in the following manner. La, Sm, Mg, Ni, and Al were mixed at a predetermined alloy composition, and the mixture was melted with a high frequency induction furnace. Thereafter, the resultant material was cooled, whereby a hydrogen-absorbing alloy ingot was obtained.

Then, the ingot was heat-treated to make it uniform in quality, and thereafter pulverized in an inert atmosphere. The pulverized material was classified to obtain hydrogen-absorbing alloy powder having an average particle size of 20 μm at a mass integral of 50%. The composition of the resultant hydrogen-absorbing alloy was analyzed by inductively-coupled plasma spectrometry (ICP). As a result, the composition was found to be La_{0.60}Sm_{0.30}Mg_{0.10}Ni_{3.70}Al_{0.10}.

Next, the hydrogen-absorbing alloy powder was heated for 2 hours at 150° C. in an air atmosphere and thereafter heat-treated at 200° C. for 1 hour in an air atmosphere, whereby an oxide layer containing NiO was formed on the surface of the hydrogen-absorbing alloy. The thickness of the oxide layer containing NiO that was formed on the surface of the hydrogen-absorbing alloy was about 50 nm.

Then, 0.5 parts by mass of styrene-butadiene copolymer rubber (SBR), serving as a binder agent, and water were added to 100 parts by mass of the hydrogen-absorbing alloy powder, followed by kneading the mixture, to obtain a negative electrode mixture slurry.

Next, the negative electrode mixture slurry was applied uniformly onto both sides of a conductive current collector made of punched metal, and then dried. The resultant material was then pressed and thereafter cut into predetermined dimensions. Thus, a negative electrode was prepared. The filling density of the negative electrode mixture in the negative electrode was 5.0 g/cm³.

### Preparation of Positive Electrode

The positive electrode was prepared in the following manner. A porous sintered nickel substrate having a porosity of about 85% was immersed into a nitric acid solution having a specific gravity of 1.75 in which nickel nitrate and cobalt nitrate were mixed so that the atomic ratio of nickel and cobalt became 10:1, to retain a nickel salt and a cobalt salt in the pores of the porous sintered nickel substrate. Thereafter, the porous sintered nickel substrate was immersed into a 25 mass % aqueous sodium hydroxide solution to convert the nickel salt and the cobalt salt into nickel hydroxide and cobalt hydroxide, respectively, so that the nickel hydroxide and the cobalt hydroxide would be retained in the pores. Subsequently, the porous sintered nickel substrate, in which nickel hydroxide and cobalt hydroxide were retained in the pores, was sufficiently washed with water to remove the alkaline solution, and then dried.

This filling process, including immersing the porous sintered nickel substrate, in which nickel hydroxide and cobalt hydroxide are retained in the pores, into the nitric acid solution, thereafter immersing the substrate into the aqueous sodium hydroxide solution, then washing the substrate, and then drying it, was repeated 6 times. Thereby, the positive electrode active material, nickel hydroxide, was filled in the pores of the porous sintered nickel substrate.

Then, the porous sintered nickel substrate, in which the positive electrode active material comprising nickel hydroxide was filled in the pores, was dried at room temperature, and thereafter cut into predetermined dimensions. Thus, the positive electrode was prepared. The filling density of this positive electrode active material in the positive electrode was 2.5 g/cm³.

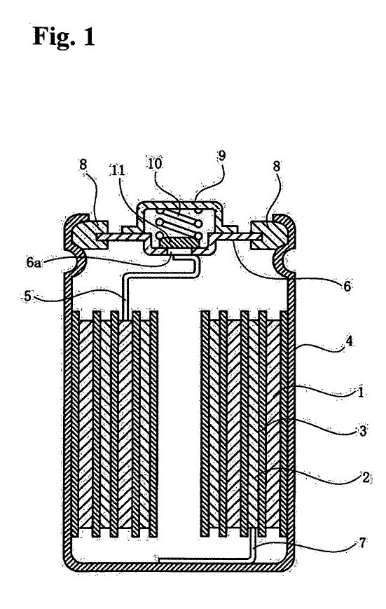

In addition, polypropylene non-woven fabric was used for the separators, and a 30 mass % aqueous potassium hydroxide solution was used as the alkaline electrolyte solution. Thus, a cylindrical alkaline storage battery as shown in FIG. 1 having a design capacity of 6000 mAh was prepared.

The just-described alkaline storage battery was assembled in the following manner, as illustrated in FIG. 1. The positive electrode 1 and the negative electrode 2, prepared in the above-described manner, were spirally coiled with the separators 3 interposed therebetween, and these were accommodated in a battery can 4. The positive electrode 1 was connected to a positive electrode cap 6 by a positive electrode lead 5, and the negative electrode 2 was connected to the battery can 4 by a negative electrode lead 7. Then, the alkaline electrolyte solution was poured into the battery can 4. Thereafter, an insulative packing 8 was placed between the battery can 4 and the positive electrode cap 6, and the battery can 4 was sealed. The battery can 4 and the positive electrode cap 6 were electrically insulated by the insulative packing 8. A closing plate 11 urged by a coil spring 10 was provided between the positive electrode cap 6 and a positive electrode external terminal 9. When the internal pressure of the battery unusually increases, the coil spring 10 can be compressed to release gas from the interior of the battery to the atmosphere through a gas discharge port formed in the positive electrode external terminal 9. The amount of the alkaline electrolyte solution was set at 2.5 g per 1 Ah of the battery capacity.

Next, the alkaline storage battery thus prepared was charged at a current of 6000 mA in an atmosphere at 25° C. for 1 hour 12 minutes, followed by a rest of 1 hour. Then, the battery was set aside in an atmosphere at 70° C. for 24 hours, and thereafter discharged in an atmosphere at 45° C. at a current of 6000 mA until the battery voltage became 0.3 V. This charge-discharge cycle was repeated two times to activate the battery. Thus, an alkaline storage battery of Example 1 was obtained.

### Comparative Example 1

In Comparative Example 1, an alkaline storage battery was prepared in the same manner as described in Example 1 above, except that when preparing the negative electrode, the hydrogen-absorbing alloy powder was not heat-treated so that the oxide layer containing NiO was not formed on the surface of the hydrogen-absorbing alloy. The alkaline storage battery thus prepared was activated by charging and discharging in the same manner as with the alkaline storage battery of Example 1 above, whereby an alkaline storage battery of Comparative Example 1 was obtained.

### Comparative Example 2

In Comparative Example 2, an alkaline storage battery was prepared using a negative electrode prepared by subjecting the hydrogen-absorbing alloy powder to an acid treatment with a hydrochloric acid solution. Specifically, an alkaline storage battery of Comparative Example 2 was prepared in the manner as described in the following paragraphs [0045] to [0052].

### Preparation of Negative Electrode

The negative electrode was prepared in the following manner. Rare-earth elements La, Pr, and Nd, and Zr, Mg, Ni, and Al were mixed at a predetermined alloy composition, and the mixture was melted with a high frequency induction furnace. Thereafter, the resultant material was cooled, whereby a hydrogen-absorbing alloy ingot was obtained.

Then, the hydrogen-absorbing alloy ingot was heat-treated to make it uniform in quality, and thereafter the hydrogen-absorbing alloy ingot was pulverized in an inert atmosphere. The pulverized material was classified to obtain hydrogen-absorbing alloy powder having a volume average particle size of 30 μm. The composition of the resultant hydrogen-absorbing alloy was analyzed by inductively-coupled plasma spectrometry (ICP). As a result, the composition was found to be (La_{0.20}Pr_{0.39}Nd_{0.40}Zr_{0.01})_{0.84}Mg_{0.16}Ni_{3.15}Al_{0.20}.

Next, 2.0 kg of the hydrogen-absorbing alloy powder thus obtained was immersed into 2 liters of hydrochloric acid solution (pH 1), and the acid treatment was performed for about 6 minutes until the pH reached 7. Thus, powder of hydrogen-absorbing alloy for alkaline storage batteries was obtained.

Then, binder agents, 0.5 parts by weight polyethylene oxide and 0.6 parts by weight of polyvinyl pyrrolidone, were added to 100 parts by weight of the hydrogen-absorbing alloy powder that was acid-treated, and the mixture was kneaded, to obtain a negative electrode mixture slurry.

Then, the negative electrode mixture slurry was applied uniformly onto both sides of a conductive current collector made of punched metal, and then dried. The resultant material was then pressed and thereafter cut into predetermined dimensions. Thus, a negative electrode was prepared. The filling density of the negative electrode mixture in the negative electrode was 5.0 g/cm³.

### Preparation of Positive Electrode

The positive electrode was prepared in the following manner. 50 parts by weight of a 0.2 weight % aqueous hydroxypropylcellulose solution was added to 100 parts by weight of the positive electrode active material, nickel hydroxide, and these were mixed together to prepare a positive electrode slurry. The slurry was then filled into a nickel foam. The resultant material was dried and pressed, and thereafter cut into predetermined dimensions. Thus, a positive electrode comprising a non-sintered nickel electrode was prepared. The filling density of this positive electrode active material in the positive electrode was 2.5 g/cm³.

An alkaline electrolyte solution used was an alkaline aqueous solution containing KOH, NaOH, and LiOH—H₂O at a weight ratio of 8:0.5:1 and in a total amount of 30 weight %. Using these components, a cylindrical alkaline storage battery as illustrated in FIG. 1 was prepared, which had a design capacity of 3,000 mAh.

Next, under a temperature condition of 25° C., the alkaline storage battery prepared in the above-described manner was charged at a current of 300 mA for 16 hours, and thereafter discharged at a current of 600 mA until the battery voltage reached 1.0 V, and subsequently, the battery was charged at a current of 300 mA for 16 hours and discharged at a current of 3,000 mA and thereafter discharged until the battery voltage reached 1.0 V. Subsequently, the alkaline storage battery was charged at a current of 3,000 mA until the battery voltage drops by 10 mV after the battery voltage reached the maximum value, and then set aside for 0.5 hours, and discharged at a current of 9000 mA until the battery voltage reached 1.0 V. The just-described charge-discharge cycle was repeated 3 times to activate the battery, whereby an alkaline storage battery of Comparative Example 2 was obtained.

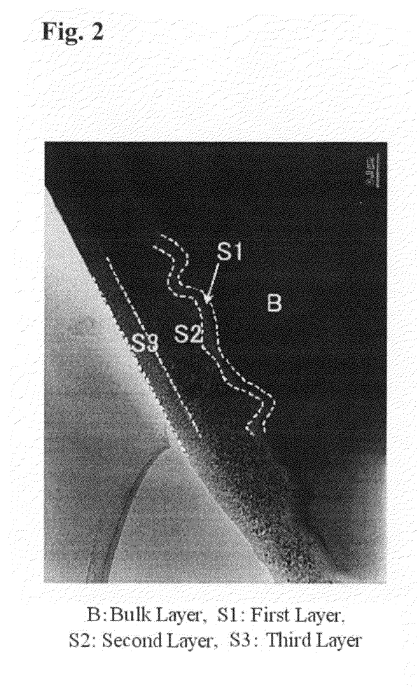

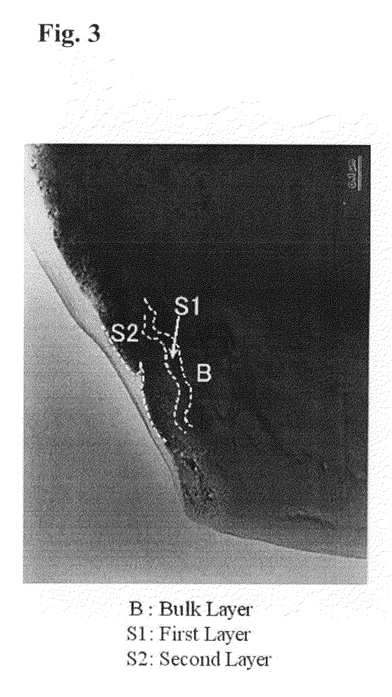

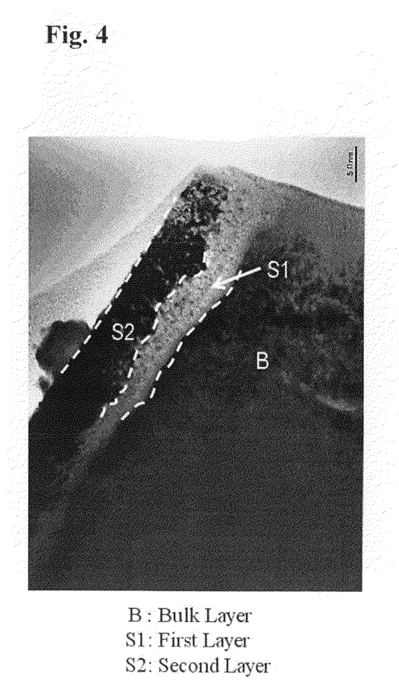

Then, the alkaline storage batteries of Example 1 and Comparative Examples 1 and 2 that were activated by charging and discharging were disassembled to take out the hydrogen-absorbing alloy in each of the negative electrodes. The hydrogen-absorbing alloys were washed to remove the alkaline electrolyte solution and the binder agents, and then dried. Thereafter, respective samples of the cross sections of the hydrogen-absorbing alloys were prepared, and the cross-sectional structure of each of the hydrogen-absorbing alloys was observed with a transmission electron microscope TEM (JEM-2010F made by JEOL Ltd.). The condition of the hydrogen-absorbing alloy in the alkaline storage battery of Example 1 is shown in FIG. 2. The condition of the hydrogen-absorbing alloy in the alkaline storage battery of Comparative Example 1 is shown in FIG. 3. The condition of the hydrogen-absorbing alloy in the alkaline storage battery of Comparative Example 2 is shown in FIG. 4.

As a result, it was observed that, in the hydrogen-absorbing alloy in the alkaline storage battery of Example 1, three layers were formed on the bulk phase B, as shown in FIG. 2. The three layers are a first layer S1 having a thickness of 20-40 nm, in which crystal grains cannot be observed, a second layer S2 having a thickness of 80-150 nm and a crystal grain size of about 10 nm, and a third layer S3 having a thickness of about 50 nm and a crystal grain size of about 5 nm.

It was also observed that, in the hydrogen-absorbing alloy in the alkaline storage battery of Comparative Example 1, only two layers were formed on the bulk phase B, as shown in FIG. 3. The two layers are the first layer S1 having a thickness of 20-40 nm, in which crystal grains cannot be observed, and the second layer S2 having a thickness of 80-150 nm and a crystal grain size of about 10 nm.

It was also observed that, in the hydrogen-absorbing alloy in the alkaline storage battery of Comparative Example 2, only two layers were formed on the bulk phase B, as shown in FIG. 4. The two layers were the first layer S1 having a thickness of 20-50 nm in which crystal grains were not observed, and the second layer S2 having a thickness of 50-80 nm and a crystal grain size of 10-15 nm.

It should be noted that in the hydrogen-absorbing alloys, the boundary between the first layer and the second layer was not clear and the crystal grain size gradually increases from the first layer toward the second layer. Therefore, the portion in which crystal grains were not clearly observed was determined as the first layer, and that in which crystal grains were clearly observed was determined as the second layer.

For the hydrogen-absorbing alloy in the alkaline storage battery of Example 1, the proportions of the elements in the bulk phase and the first to third layers were determined by a TEM-EDS system (UTW type Si (Li) semiconductor detector made by Noran Inc.). In addition, for each of the second and third layers, the percentage of the amount of Ni within the NiO with respect to the total amount of Ni within the NiO and the metallic Ni was obtained from the amount of oxygen in the constituent elements. The results are shown in Table 1 below. Specifically, the just-mentioned percentage for each of the layers was calculated assuming that all the rare-earth elements and metallic elements other than Ni form oxides with the oxygen in the layers and all the remaining oxygen in the layers forms NiO.

TABLE 1

| | | | | | | | | Percentage |
|---|---|---|---|---|---|---|---|---|
| | | | | | | | | of Ni within |
| | Layer | | | | | | | NiO with |
| | thickness | Constituent elements (atom %) | | | | | | respect to |
| | (nm) | La | Sm | Mg | Ni | Al | O | the total Ni |
| Bulk | — | 11.9 | 7.5 | 1.2 | 71.8 | 2.0 | 5.5 | — |
| phase | | | | | | | | |
| 1st layer | 20-40 | 9.6 | 6.6 | 0.6 | 58.8 | 1.9 | 22.5 | — |
| 2nd layer | 80-150 | 1.3 | 0.6 | 0.0 | 83.5 | 0.0 | 14.6 | 13.9% |
| 3rd layer | 50 | 0.6 | 0.1 | 0.0 | 64.2 | 0.2 | 34.9 | 52.1% |

The results indicate that in the hydrogen-absorbing alloy in the alkaline storage battery of Example 1, almost no metal component other than Ni exists in the second and third layers, and in the first layer, the rare-earth elements soluble in an alkaline solution, Al, and Mg are in a condition close to an alloy bulk phase. The oxygen amounts in the first to third layers were as follows. The first layer and the third layer had greater amounts of oxygen, while the second layer, located between the two layers, had a lesser amount of oxygen. The amount of oxygen in the first layer was about 1.5 times that of the second layer.

From an electron diffraction analysis, it was found that the second layer primarily contained primarily metallic Ni, and the third layer contained primarily NiO. In the second layer, the percentage of the amount of Ni within the NiO with respect to the total amount of Ni within the NiO and the metallic Ni was 13.9%. On the other hand, in the third layer, the percentage was 52.1%, and the NiO content in the third layer was higher than the NiO content in the second layer.

Also for Comparative Examples 1 and 2, the proportions of the constituent elements were determined using the TEM-EDS system. For the hydrogen-absorbing alloy in the alkaline storage battery of Comparative Example 1, the first layer was in a condition close to an alloy bulk phase, and the second layer contained less amounts of the rare earth elements and metallic elements other than Ni. For the hydrogen-absorbing alloy in the alkaline storage battery of Comparative Example 2, it was found that the first layer was in a condition close to an alloy bulk phase, and the second layer contained less amounts of the metal elements other than the rare earth elements and Ni than Comparative Example 1. Moreover, from an electron diffraction analysis, it was found that Ni within the second layer of each of Comparative Examples 1 and 2 exists primarily in the form of metallic Ni.

Next, the alkaline storage batteries of Example 1 and Comparative Example 1, activated by charging and discharging in the previously-described manner, were charged at a charge current of 6,000 mA for 30 minutes in an atmosphere at 25° C., followed by a rest of 1 hour.

Thereafter, in an atmosphere at −30° C., discharge I-V profile of each batteries was determined in the following manner. Each of the batteries was charged for 20 seconds at a current of 1,800 mA, followed by a rest of 30 minutes, and thereafter discharged at a current of 4,200 mA for 10 seconds, followed by a rest of 30 minutes. Then, each of the batteries was charged at a current of 4,200 mA for 20 seconds, followed by a rest of 30 minutes, and thereafter discharged at a current of 7,800 mA for 10 seconds, followed by a rest of 30 minutes. Then, each of the batteries was charged at a current of 6,000 mA for 20 seconds, followed by a rest of 30 minutes, and thereafter discharged at a current of 12,000 mA for 10 seconds, followed by a rest of 30 minutes. Then, each of the batteries was charged at a current of 7,800 mA for 20 seconds, followed by a rest of 30 minutes, and thereafter discharged at a current of 16,200 mA for 10 seconds, followed by a rest of 30 minutes. Then, each of the batteries was charged at a current of 10,200 mA for 20 seconds, followed by a rest of 30 minutes, and thereafter discharged at a current of 19,800 mA for 10 seconds. The battery voltage of each of the batteries was measured 10 seconds after each discharge process at the respective discharge currents, and each of the discharge currents and battery voltages were plotted to determine the discharge I-V profile of each of the alkaline storage batteries in an atmosphere at −30° C.

Then, the discharge current of each of the alkaline storage batteries at 0.9 V in an atmosphere at −30° C. was determined based on the just-mentioned discharge I-V profile, to determine the low-temperature discharge power of each of the alkaline storage batteries under a low temperature of −30° C., and the low-temperature discharge power characteristic of the alkaline storage battery of Example 1 was calculated by assuming the low-temperature discharge power of the alkaline storage battery of Comparative Example 1 as a low-temperature discharge power characteristic of 100. The results are shown in Table 2 below.

In addition, the alkaline storage batteries of Example 1 and Comparative Example 1, activated by charging and discharging in the previously-described manner, were charged at a charge current of 6,000 mA for 30 minutes in an atmosphere at 25° C., followed by a rest of 1 hour.

Thereafter, in an atmosphere at 25° C., discharge I-V profile of each batteries was determined in the following manners. Each of the batteries was charged for 20 seconds at a current of 2,400 mA, followed by a rest of 30 minutes, and thereafter discharged at a current of 10,200 mA for 10 seconds, followed by a rest of 30 minutes. Then, each of the batteries was charged at a current of 10,200 mA for 20 seconds, followed by a rest of 30 minutes, and thereafter discharged at a current of 19,800 mA for 10 seconds, followed by a rest of 30 minutes. Then, each of the batteries was charged at a current of 15,000 mA for 20 seconds, followed by a rest of 30 minutes, and thereafter discharged at a current of 30,000 mA for 10 seconds, followed by a rest of 30 minutes. Then, each of the batteries was charged at a current of 19,800 mA for 20 seconds, followed by a rest of 30 minutes, and thereafter discharged at a current of 40,200 mA for 10 seconds, followed by a rest of 30 minutes. Then, each of the batteries was charged at a current of 25,200 mA for 20 seconds, followed by a rest of 30 minutes, and thereafter discharged at a current of 49,800 mA for 10 seconds. The battery voltage of each of the batteries was measured 10 seconds after each discharge process at the respective discharge currents, and each of the discharge currents and battery voltages were plotted to determine the discharge I-V profile of each of the alkaline storage batteries in an atmosphere at 25° C.

Then, the discharge current of each of the alkaline storage batteries at 0.9 V in an atmosphere at 25° C. was obtained based on the discharge I-V profile, and the discharge power IPx of each of the alkaline storage batteries at 25° C. was calculated.

Next, the alkaline storage batteries of Example 1 and Comparative Example 1 whose IPx had been determined were charged at a charge current of 6,000 mA in an atmosphere at 25° C. for 30 minutes. Thereafter, an intermittent charge-discharge operation at a current of 50 A was repeated with the batteries for 18,000 cycles in an atmosphere at 45° C., while controlling the batteries so that the state of charge (SOC) could be kept within the range of from 40% to 60%.

Using each of the alkaline storage batteries that had undergone 18,000 repeated cycles of the intermittent charge-discharge operation, the I-V profile of each of the alkaline storage batteries in an atmosphere at 25° C. was determined, to calculate the discharge power IPy at 25° C. of each of the alkaline storage batteries, and the output power deterioration rate after 18,000 cycles was determined by the equation below. By assuming the output power deterioration rate of the alkaline storage battery of Comparative Example 1 as a output power deterioration rate of 100, the output power deterioration rate of the alkaline storage battery of Example 1 was calculated. The results are shown in Table 2 below.

Output power deterioration rate after 18,000 cycles=(IPx−IPy)/IPx

TABLE 2

| | Low-temperature | Output |
|---|---|---|
| | discharge power | power deterioration |
| | characteristic at −30° C. | after 18,000 cycles |
| Ex. 1 | 111 | 85 |
| Comp. Ex. 1 | 100 | 100 |

The results indicate the following. The alkaline storage battery of Example 1, which uses the hydrogen-absorbing alloy in which three layers, namely, the first to third layers, are formed on the bulk phase, shows significant improvements in low-temperature discharge power characteristic over the alkaline storage battery of Comparative Example 1, which uses the hydrogen-absorbing alloy in which only two layers, namely, the first and second layers, are formed on the bulk phase. Moreover, the alkaline storage battery of Example 1 shows remarkably less output power deterioration than the alkaline storage battery of Comparative Example 1. Thus, the alkaline storage battery of Example 1 achieves excellent output power and life characteristics.

### Example 1a

In Example 1a, a hydrogen-absorbing alloy electrode used for the negative electrode was prepared in the following manner. In the same manner as described in Example 1 above, hydrogen-absorbing alloy powder having a composition of La_{0.60}Sm_{0.30}Mg_{0.10}Ni_{3.70}Al_{0.10} was heated in an air atmosphere at 150° C. for 2 hours, and further heat-treated in an air atmosphere at 200° C. for 1 hour to form an oxide layer containing NiO on the surface of the hydrogen-absorbing alloy. Then, 3 parts by mass of nickel powder serving as a conductive agent was mixed with 1 part by mass of the resultant hydrogen-absorbing alloy powder, and the mixture was pressure-formed in a pellet form. Thus, a hydrogen-absorbing alloy electrode having a capacity of 90 mAh was prepared.

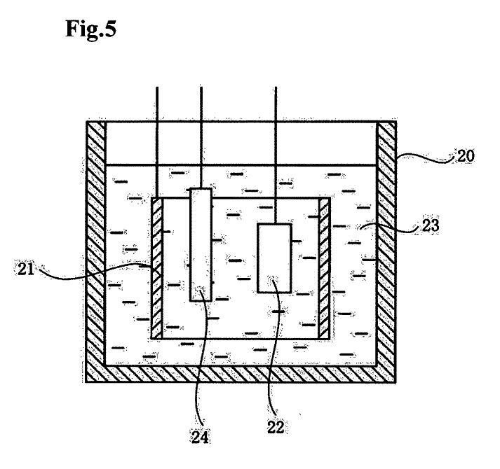

Using a hydrogen-absorbing alloy electrode prepared in the above-described manner as the negative electrode, a cylindrically-formed sintered nickel electrode having an excess capacity relative to the negative electrode as the positive electrode, and a 30 mass % potassium hydroxide aqueous solution as the alkaline electrolyte solution, a test cell as shown in FIG. 5 was prepared.

Here, in the test cell, the foregoing alkaline electrolyte solution 23 was filled in a polypropylene container 20. Then, the negative electrode 22 and a reference electrode 24 comprising a mercury oxide electrode were accommodated in the cylindrically formed positive electrode 21. In this condition, the positive electrode 21, the negative electrode 22, and the reference electrode 24 were immersed into the alkaline electrolyte solution 23.

Then, the above-described test cell was charged at a current of 45 mA for 170 minutes in an atmosphere at 25° C., followed by a rest of 10 minutes, and thereafter, the cell was discharged at a current of 45 mA until the potential of the negative electrode with respect to the reference electrode reached −0.7 V, followed by a rest of 20 minutes. This charge-discharge cycle was repeated 8 times to activate the test cell.

### Example 2a

In Example 2a, a hydrogen-absorbing alloy electrode was prepared in the same manner as described in Example 1a above, except that hydrogen-absorbing alloy powder having a composition of La_{0.60}Sm_{0.30}Mg_{0.10}Ni_{3.70}Al_{0.10} was heated in an air atmosphere at 150° C. for 2 hours, and further heat-treated in an air atmosphere at 200° C. for 0.25 hours, to form an oxide layer containing NiO on the surface of the hydrogen-absorbing alloy. A test cell was also prepared in the same manner as described in Example 1a above, except for using the hydrogen-absorbing alloy electrode prepared in the just-described manner. The test cell prepared in this manner was activated by charging and discharging the cell in the same manner as with the test cell of Example 1a above.

### Example 3a

In Example 3a, a hydrogen-absorbing alloy electrode was prepared in the same manner as described in Example 1a above, except that hydrogen-absorbing alloy powder having a composition of La_{0.60}Sm_{0.30}Mg_{0.10}Ni_{3.70}Al_{0.10} was heated in an air atmosphere at 150° C. for 2 hours, and further heat-treated in an air atmosphere at 200° C. for 0.5 hours, to form an oxide layer containing NiO on the surface of the hydrogen-absorbing alloy. A test cell was also prepared in the same manner as described in Example 1a above, except for using the hydrogen-absorbing alloy electrode prepared in the just-described manner. The test cell prepared in this manner was activated by charging and discharging the cell in the same manner as with the test cell of Example 1a above.

### Example 4a

In Example 4a, a hydrogen-absorbing alloy electrode was prepared in the same manner as described in Example 1a above, except that hydrogen-absorbing alloy powder having a composition of La_{0.60}Sm_{0.30}Mg_{0.10}Ni_{3.70}Al_{0.10} was heated in an air atmosphere at 150° C. for 2 hours, and further heat-treated in an air atmosphere at 200° C. for 2 hours, to form an oxide layer containing NiO on the surface of the hydrogen-absorbing alloy. A test cell was also prepared in the same manner as described in Example 1a above, except for using the hydrogen-absorbing alloy electrode prepared in the just-described manner. The test cell prepared in this manner was activated by charging and discharging the cell in the same manner as with the test cell of Example 1a above.

### Comparative Example 1a

In Comparative Example 1a, a hydrogen-absorbing alloy electrode was prepared in the same manner as described in Example 1a above, except that hydrogen-absorbing alloy powder having a composition of La_{0.60}Sm_{0.30}Mg_{0.10}Ni_{3.70}Al_{0.10} was not heat-treated as in Comparative Example 1 above so that no oxide layer containing NiO was formed on the surface of the hydrogen-absorbing alloy. A test cell was also prepared in the same manner as described in Example 1a above, except for using the hydrogen-absorbing alloy electrode prepared in the just-described manner. The test cell prepared in this manner was activated by charging and discharging the cell in the same manner as with the test cell of Example 1a above.

The cross-sectional structure of each of the hydrogen-absorbing alloys of Examples 1a to 4a and Comparative Example 1a that had been heat-treated was observed with a transmission electron microscope TEM (JEM-2010F made by JEOL Ltd.). As a result, it was found that a layer with a thickness of 34-68 nm as the third layer was formed over the bulk phase of each of the hydrogen-absorbing alloys of Example 1a to 4a, as in Example 1 above after having been activated. On the other hand, the third layer was not observed in the hydrogen-absorbing alloy of Comparative Example 1a. For the hydrogen-absorbing alloys of Examples 1a to 4a above, the thickness of the third layer in the outermost surface of each of the hydrogen-absorbing alloys was obtained. The results are shown in Table 3 below.

In addition, each of the test cells of Examples 1a to 4a and Comparative Example 1a activated in the above-described manner was charged at a charge current of 45 mA in an atmosphere at 25° C. for 170 minutes, rested for 10 minutes, and thereafter further rested in an atmosphere at −20° C. for 4 hours. Thereafter, each of the batteries was discharged at a discharge current of 45 mA in an atmosphere at −20° C. until the potential of the negative electrode with respect to the reference electrode reached −0.7 V, to determine the discharge capacity at −20° C. of each of the test cells. By assuming the discharge capacity of the test cell of Comparative Example 1a as a low temperature discharge capability of 100, the low temperature discharge capability of each test cell of Examples 1a to 4a was calculated. The results are shown in Table 3 below.

TABLE 3

| | | | Low- |
|---|---|---|---|
| | | Thickness | temperature |
| | Heat treatment conditions for | of the | discharge |
| | hydrogen-absorbing alloy | third layer | capability |
| Ex. 2a | 150° C., 2 hrs. + 200° C., 0.25 hrs. | 34 nm | 104 |
| Ex. 3a | 150° C., 2 hrs. + 200° C., 0.5 hrs. | 40 nm | 110 |
| Ex. 1a | 150° C., 2 hrs. + 200° C., 1 hr. | 50 nm | 117 |
| Ex. 4a | 150° C., 2 hrs. + 200° C., 2 hrs. | 68 nm | 111 |
| Comp. | — | — | 100 |
| Ex. 1a | | | |

The results indicate the following. The test cells of Examples 1a to 4a, which use the hydrogen-absorbing alloy in which three layers, namely, the first to third layers, are formed on the bulk phase, showed higher low temperature discharge capabilities than the test cell of Comparative Example 1a, which uses the hydrogen-absorbing alloy in which only two layers, namely, the first and second layers, are formed on the bulk phase. This means that the test cells of Examples 1a to 4a showed higher discharge capacities under a low temperature at −20° C. than the test cell of Comparative Example 1a.

In addition, when comparing the test cells of Examples 1a to 4a with each other, the test cells of Examples 1a, 3a, and 4a, in which the thickness of the third layer in the outermost surface of the hydrogen-absorbing alloy was 40 nm or greater, showed higher low temperature discharge capabilities than the test cell of Example 2a, in which the thickness of the third layer in the outermost surface of the hydrogen-absorbing alloy was less than 40 nm. This means that the test cells of Examples 1a, 3a, and 4a exhibited a further higher discharge capacity under a low temperature of −20° C.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A negative electrode for alkaline storage batteries, comprising a hydrogen-absorbing alloy represented by the represented by the general formula Ln₁₋ₓMgₓNi_{y-a-b}AlₐM_{b}, where Ln is at least one element selected from Zr, Ti, and a rare-earth element including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9, the hydrogen-absorbing alloy having three layers layered on a surface of a bulk phase of the hydrogen-absorbing alloy, the three layers being first to third layers, wherein: the first layer located on the bulk phase contains oxygen in a greater amount than the second layer located on the first layer and contains at least one element soluble in an alkaline solution in an amount of 10 atom %; the second layer located on the first layer has a higher Ni content than the bulk phase; and the third layer located on the second layer has a higher NiO content than that in the second layer.

2. The negative electrode for alkaline storage batteries according to claim 1, wherein the third layer contains NiO and metallic Ni.

3. The negative electrode for alkaline storage batteries according to claim 1, wherein the total amount of oxygen and Ni is 90 atom % or greater in the elements contained in the third layer.

4. The negative electrode for alkaline storage batteries according to claim 2 wherein, in the third layer, the percentage of the amount of Ni within the NiO with respect to the total amount of Ni within the NiO and the metallic Ni is from 20% to 99%.

5. The negative electrode for alkaline storage batteries according to claim 4, wherein the total amount of oxygen and Ni is 90 atom % or greater in the elements contained in the third layer.

6. The negative electrode for alkaline storage batteries according to claim 2, wherein the total amount of oxygen and Ni is 90 atom % or greater in the elements contained in the third layer.

7. The negative electrode for alkaline storage batteries according to claim 1, wherein the third layer has a thickness of from 10 nm to 100 nm.

8. The negative electrode for alkaline storage batteries according to claim 1, wherein the grain size of the crystal grains existing in the third layer is smaller than the grain size of the crystal grains existing in the second layer.

9. The negative electrode for alkaline storage batteries according to claim 1, wherein the crystal grains existing in the third layer consists of crystal grains having a grain size of 7 nm or less.

10. The negative electrode for alkaline storage batteries according to claim 7, wherein the grain size of the crystal grains existing in the third layer is smaller than the grain size of the crystal grains existing in the second layer.

11. The negative electrode for alkaline storage batteries according to claim 10, wherein the crystal grains existing in the third layer consists of crystal grains having a grain size of 7 nm or less.

12. The negative electrode for alkaline storage batteries according to claim 8, wherein the crystal grains existing in the third layer consists of crystal grains having a grain size of 7 nm or less.

13. The negative electrode for alkaline storage batteries according to claim 1, wherein the at least one element soluble in an alkaline solution in the first layer includes Ln, Al, and Mg in the general formula.

14. The negative electrode for alkaline storage batteries, according to claim 5, wherein:
the third layer has a thickness of from 10 nm to 100 nm;
the grain size of the crystal grains existing in the third layer is smaller than the grain size of the crystal grains existing in the second layer;
the crystal grains existing in the third layer consists of crystal grains having a grain size of 7 nm or less; and
the at least one element soluble in an alkaline solution in the first layer includes Ln, Al, and Mg in the general formula.

15. An alkaline storage battery comprising a positive electrode, a negative electrode containing a hydrogen-absorbing alloy, and an alkaline electrolyte solution, the negative electrode being a negative electrode for alkaline storage batteries according to claim 1.

16. A method of manufacturing an alkaline storage battery, the method comprising:
subjecting a hydrogen-absorbing alloy represented by the general formula Ln₁₋ₓMgₓNi_{y-a-b}AlₐM_{b}, where Ln is at least one element selected from Zr, Ti, and a rare-earth element including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9, to an oxidation treatment to form an oxide layer containing NiO on a surface of the hydrogen-absorbing alloy;
preparing a negative electrode from the hydrogen absorbing alloy having an oxide layer containing NiO on a surface thereof;
combining the negative electrode, a positive electrode and an alkaline electrolyte solution to form a preliminary alkaline storage battery; and
charging and discharging the preliminary alkaline storage battery to form three layers layered on a surface of a bulk phase of the hydrogen-absorbing alloy on which the oxide layer containing NiO is formed and obtain the alkaline storage battery, the three layers being first to third layers, wherein: the first layer located on the bulk phase contains oxygen in a greater amount than the second layer located on the first layer and contains at least one element soluble in an alkaline solution in an amount of 10 atom %; the second layer located on the first layer has a higher Ni content than the bulk phase; and the third layer located on the second layer has a higher NiO content than that in the second layer.

17. The method according to claim 16, wherein, in the step of subjecting the hydrogen-absorbing alloy to an oxidation treatment, the hydrogen-absorbing alloy is heat-treated in an atmosphere containing oxygen at a temperature of 150° C. or higher.

18. A method of manufacturing an alkaline storage battery, the method comprising:
subjecting a hydrogen-absorbing alloy represented by the general formula Ln₁₋ₓMgₓNi_{y-a-b}AlₐM_{b}, where Ln is at least one element selected from Zr, Ti, and a rare-earth element including Y; M is at least one element selected from the group consisting of V, Nb, Ta, Cr, Mo, Mn, Fe, Co, Ga, Zn, Sn, In, Cu, Si, P, and B; 0.05≦x≦0.30; 0.05≦a≦0.30; 0≦b≦0.50; and 2.8≦y≦3.9, to an oxidation treatment at a temperature of 150° C. or higher to form an oxide layer containing NiO on a surface of the hydrogen-absorbing alloy;
preparing a negative electrode from the hydrogen absorbing alloy having an oxide layer containing NiO on a surface thereof;
combining the negative electrode, a positive electrode and an alkaline electrolyte solution to form a preliminary alkaline storage battery; and
charging and discharging the preliminary alkaline storage battery to form three layers layered on a surface of a bulk phase of the hydrogen-absorbing alloy on which the oxide layer containing NiO is formed and obtain the alkaline storage battery, the three layers being first to third layers, wherein: the first layer located on the bulk phase contains oxygen in a greater amount than the second layer located on the first layer and contains at least one element soluble in an alkaline solution in an amount of 10 atom %; the second layer located on the first layer has a higher Ni content than the bulk phase; and the third layer located on the second layer has a higher NiO content than that in the second layer;
wherein the third layer contains NiO and metallic Ni;
the total amount of oxygen and Ni is 90 atom % or greater in the elements contained in the third layer;
the third layer has a thickness of from 10 nm to 100 nm;
the grain size of the crystal grains existing in the third layer is smaller than the grain size of the crystal grains existing in the second layer;
the crystal grains existing in the third layer consists of crystal grains having a grain size of 7 nm or less; and
the at least one element soluble in an alkaline solution in the first layer includes Ln, Al, and Mg in the general formula.
